(19) United States
(12) Patent Application Publication
(10) Pub. No.: US 2008/0143708 A1
(43) Pub. Date: Jun. 19, 2008

(54) SYSTEM AND METHOD FOR AUTO-DIMENSIONING BOUNDARY REPRESENTATION MODEL

(76) Inventors: John Owen, Cambridge (GB); Michael Atkins, Cambridge (GB)

Correspondence Address: SIEMANS PRODUCT LIFECYCLE MANAGEMENT SOFTWARE INC., 5800 GRANITE PARKWAY, SUITE 600, PLANO, TX, 75024, US

(21) Appl. No.: 11/612,256

(22) Filed: Dec. 18, 2006

(51) Int. Cl. G06T 15/00

(52) U.S. Cl. 345/419

(57) ABSTRACT

A system, method, and computer program for modifying a model, comprising the steps of reading a model geometry into a constraint solver; generating a set of base values from said constraint solver; applying said set of base values to said model geometry; recalculating said model geometry in response to a plurality of modified values; and regenerating a valid model from said recalculated model geometries and appropriate means and computer-readable instructions.

### TECHNICAL FIELD

The presently preferred embodiment of the innovations described herein relate generally to three-dimensional models. More specifically, the presently preferred embodiment relates to auto-dimensioning to support editing of boundary representation models.

### BACKGROUND

Computer aided drafting (CAD) systems allow engineers to design three-dimensional geometric models. These systems contain a wide range of tools that assist with building models from scratch. However, it is also very important to be able to modify the geometry of an existing model of a part. This ability can be used to correct errors earlier in the design process or to create a variant of an existing model. In order to modify an existing model, knowledge of the existing model is essential, particularly knowledge of how the part was constructed is required.

The commercial applications available today lack the ability to allow the modification of models in circumstances where the method by which the model was created is no longer available. Further, those applications are limited in their ability to allow modifications to the model where the modifications are not easily represented in the design feature structure (history-tree) of the part.

What is needed is a method for auto-dimensioning boundary representation models when modifications are to be made in a CAD system which is different from the one in which the model of the part was created.

### SUMMARY

To achieve the foregoing, and in accordance with the purpose of the presently preferred embodiment as broadly described herein, the present application provides a method of modifying a model, comprising the steps of reading a model geometry into a constraint solver; generating a set of base values from said constraint solver; applying said set of base values to said model geometry; recalculating said model geometry in response to a plurality of modified values; and regenerating a valid model from said recalculated model geometries. The method, wherein said model geometry is a boundary representation model. The method, wherein said model geometry is a subset of said model geometry. The method, wherein said base values are constraints. The method, wherein said base values are dimensions. The method, wherein said plurality of modified values is of at least one dimension. The method, wherein said recalculated model geometries creates a new model geometry. The method, further comprising the step of representing a plurality of vertices and faces from said model geometry as a plurality of points and surfaces. The method, further comprising the step of applying a plurality of coincident constraints between said plurality of points and surfaces. The method, further comprising the step of determining a plurality of predetermined pairs of a plurality of geometries that satisfy a plurality of relationships. The method, further comprising the step of determining a plurality of desirable dimension values. The method, further comprising the step of applying said dimension values to said constraint solver. The method, further comprising the step of changing a plurality of dimension values. The method, wherein said plurality of predetermined pairs are one of parallel, perpendicular, tangent, concentric, and geometrically coincident surfaces. The method, wherein said plurality of desirable dimension values is a radius of one of a sphere, a cylinder, and a torus. The method, wherein said plurality of desirable dimension values is a distance between a pair of selected geometries. The method, wherein said plurality of desirable dimensions is an angle between a pair of selected geometries.

Another advantage of the presently preferred embodiment is to provide a method of modifying a model, comprising the steps of representing a geometry as a plurality of points and a plurality of surfaces; applying a plurality of coincident constraints among said geometry; determining a plurality of constraints satisfying said plurality of points and said plurality of surfaces; adding at least one dimension to a model geometry; re-computing said geometry to satisfy said at least one dimension and said plurality of constraints; and regenerating a valid model from said re-computed geometry. The method, wherein said geometry is a subset geometry. The method, wherein said geometry consists primarily of a plurality of vertices and a plurality of surfaces. The method, further comprising the step of applying a plurality of dimensions to a solver, wherein said solver changes said model geometry. The method, further comprising the step of adding a plurality of dimensions to said model geometry. The method, further comprising the step of modifying at least one dimension value. The method, further comprising the step of removing at least one dimension from said model geometry. The method, further comprising the step of removing at least one constraint from said model geometry.

And another advantage of the presently preferred embodiment is to provide a computer-program product tangibly embodied in a machine readable medium to perform method of modifying a model, comprising instructions for reading a model geometry into a constraint solver; instructions for generating a set of base values from said constraint solver; instructions for applying said set of base values to said model geometry; instructions for recalculating said model geometry in response to a plurality of modified values; and instructions for regenerating a valid model from said recalculated model geometries. The computer-program product, wherein said model geometry is a boundary representation model. The computer-program product, wherein said model geometry is a subset of said model geometry. The computer-program product, wherein said base values are constraints. The computer-program product, wherein said base values are dimensions. The computer-program product, wherein said plurality of modified values is of at least one dimension. The computer-program product, wherein said recalculated model geometries creates a new model geometry. The computer-program product, further comprising instructions for representing a plurality of vertices and faces from said model geometry as a plurality of points and surfaces. The computer-program product, further comprising instructions for applying a plurality of coincident constraints between said plurality of points and surfaces. The computer-program product, further comprising instructions for determining a plurality of predetermined pairs of a plurality of geometries that satisfy a plurality of relationships. The computer-program product, further comprising instructions for determining a plurality of desirable dimension values. The computer-program product, further comprising instructions for applying said dimension values to said constraint solver. The computer-program product, further comprising instructions for changing a plurality of dimension values. The computer-program product, wherein said plurality of predetermined pairs are one of parallel, perpendicular, tangent, concentric, and geometrically coincident surfaces. The computer-program product, wherein said plurality of desirable dimension values is a radius of one of a sphere, a cylinder, and a torus. The computer-program product, wherein said plurality of desirable dimension values is a distance between a pair of selected geometries. The computer-program product, wherein said plurality of desirable dimensions is an angle between a pair of selected geometries.

And still another advantage of the presently preferred embodiment is to provide a computer-program product tangibly embodied in a machine readable medium to perform method of modifying a model, comprising instructions for representing a geometry as a plurality of points and a plurality of surfaces; instructions for applying a plurality of coincident constraints among said geometry; instructions for determining a plurality of constraints satisfying said plurality of points and said plurality of surfaces; instructions for adding at least one dimension to a model geometry; instructions for re-computing said geometry to satisfy said at least one dimension and said plurality of constraints; and instructions for regenerating a valid model from said re-computed geometry. The computer-program product, wherein said geometry is a subset geometry. The computer-program product, wherein said geometry consists primarily of a plurality of vertices and a plurality of surfaces. The computer-program product, further comprising instructions for applying a plurality of dimensions to a solver, wherein said solver changes said model geometry. The computer-program product, further comprising instructions for adding a plurality of dimensions to said model geometry. The computer-program product, further comprising instructions for modifying at least one dimension value. The computer-program product, further comprising instructions for removing at least one dimension from said model geometry. The computer-program product, further comprising instructions for removing at least one constraint from said model geometry.

And yet still another advantage of the presently preferred embodiment is to provide a data processing system having at least a processor and accessible memory to implement a method of modifying a model, comprising means for reading a model geometry into a constraint solver; means for generating a set of base values from said constraint solver; means for applying said set of base values to said model geometry; means for recalculating said model geometry in response to a plurality of modified values; and means for regenerating a valid model from said recalculated model geometries.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a data flow diagram of the method employed by the presently preferred embodiment;

FIGS. 2a and 2b illustrate a more detailed data flow diagram of a method employed by the presently preferred embodiment;

FIGS. 3A & 3B illustrate a three-dimensional boundary representation model;

FIG. 4 illustrates a three-dimensional boundary representation model with constraints and dimensions applied;

FIG. 5 illustrates a result on a three-dimensional boundary representation model with modified constraints and dimensions applied to it;

FIG. 6 illustrates the transition from initial solid sphere to a modified form; and

FIG. 7 is a block diagram of a computer environment in which the presently preferred embodiment may be practiced.

### DETAILED DESCRIPTION OF THE PREFERRED EMBODIMENTS

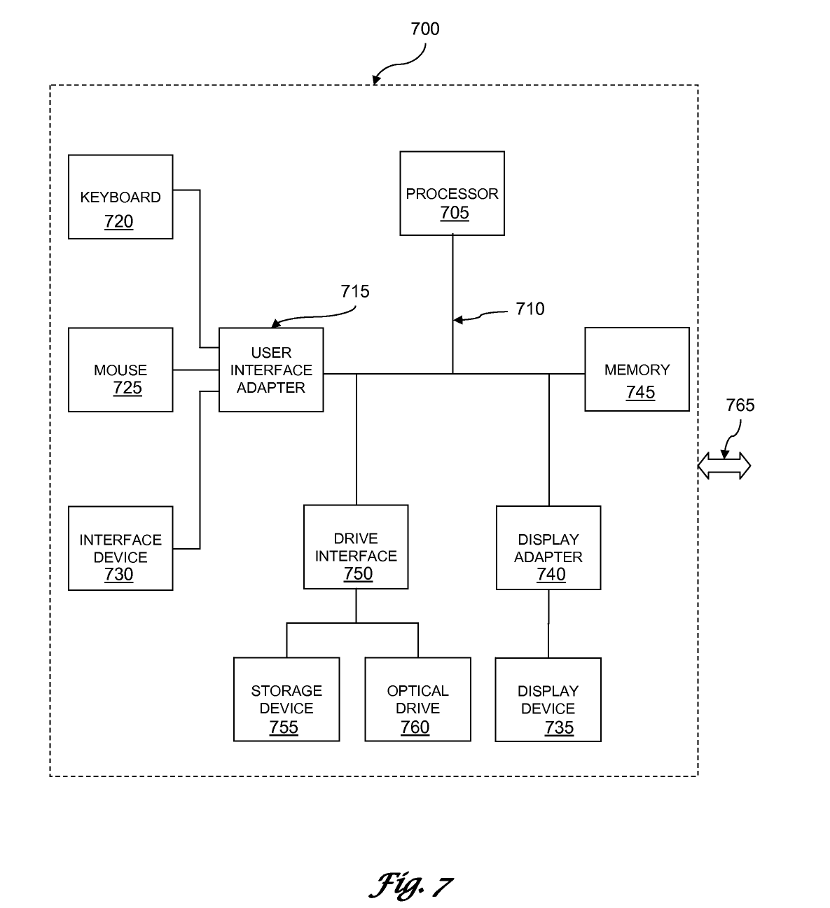

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for auto-dimensioning to support editing of boundary representation models. Now therefore, in accordance with the presently preferred embodiment, an operating system executes on a computer, such as a general-purpose personal computer. FIG. 7 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

Referring to FIG. 7, an exemplary system for implementing the presently preferred embodiment includes a general-purpose computing device in the form of a computer 700, such as a desktop or laptop computer, including a plurality of related peripheral devices (not depicted). The computer 700 includes a microprocessor 705 and a bus 710 employed to connect and enable communication between the microprocessor 705 and a plurality of components of the computer 700 in accordance with known techniques. The bus 710 may be any of several types of bus structures including a memory bus or memory controller, a peripheral bus, and a local bus using any of a variety of bus architectures. The computer 700 typically includes a user interface adapter 715, which connects the microprocessor 705 via the bus 710 to one or more interface devices, such as a keyboard 720, mouse 725, and/or other interface devices 730, which can be any user interface device, such as a touch sensitive screen, digitized pen entry pad, etc. The bus 710 also connects a display device 735, such as an LCD screen or monitor, to the microprocessor 705 via a display adapter 740. The bus 710 also connects the microprocessor 705 to a memory 745, which can include ROM, RAM, etc.

The computer 700 further includes a drive interface 750 that couples at least one storage device 755 and/or at least one optical drive 760 to the bus. The storage device 755 can include a hard disk drive, not shown, for reading and writing to a disk, a magnetic disk drive, not shown, for reading from or writing to a removable magnetic disk drive. Likewise the optical drive 760 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 700.

The computer 700 can communicate via a communications channel 765 with other computers or networks of computers. The computer 700 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 745 of the computer 700. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### System

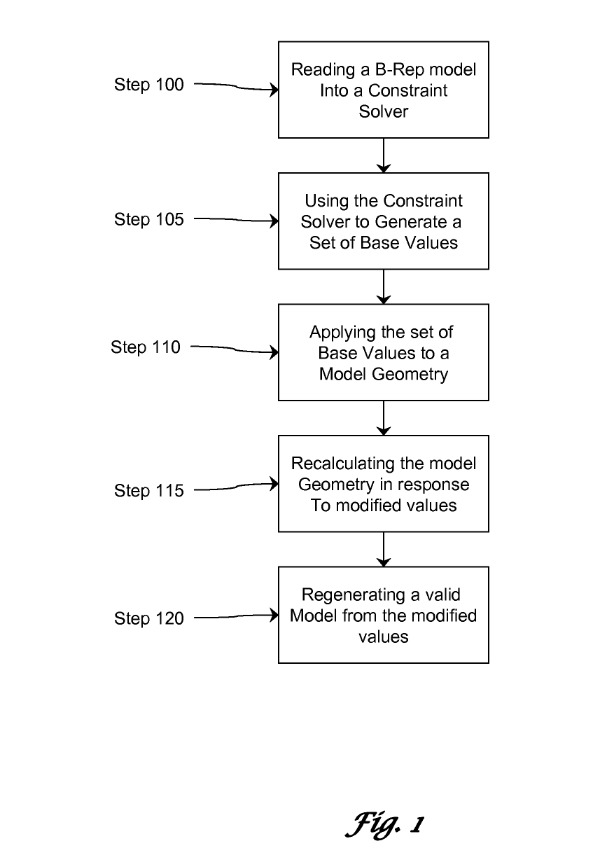

FIG. 1 is a data flow diagram of the method employed by the presently preferred embodiment. Referring to FIG. 1, the presently preferred embodiment discloses a method that reads a boundary representation model into a constraint solver (Step 100). The constraint solver generates a set of constraints and dimensions (Step 105) that are applied to the geometry within the boundary representation model (Step 110). The geometry is recalculated in response to modified values of one or more of the dimensions (Step 115). The recalculated geometry is used to regenerate a valid boundary representation model from the modified geometry positions (Step 120).

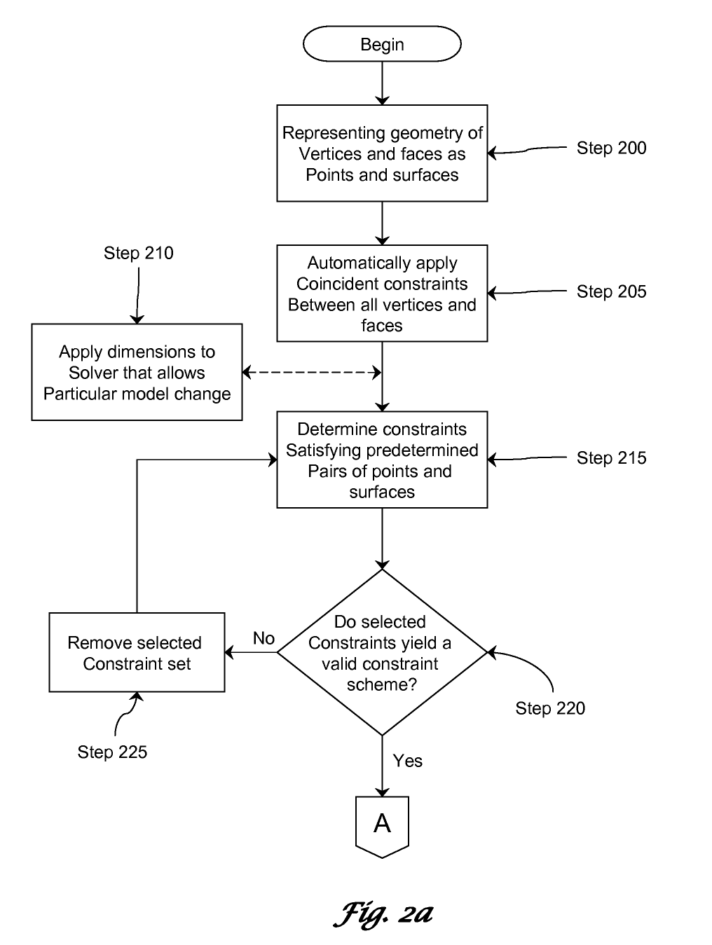

FIG. 2 is a more detailed data flow diagram of the method employed by the presently preferred embodiment. Referring to FIG. 2, read the boundary representation of a model into the constraint solver and represent the geometry of vertices and faces as points and surfaces (Step 200). Automatically apply coincident constraints between all vertices (points) and faces (surfaces) to which they are connected in the model (Step 205). Optionally, apply dimensions to the constraint solver that allow the model to be changed in a particular way; in many cases dimensions can be applied semi-automatically (see below) which will give the desired degree of control so this step is not always needed (Step 210). Determine constraints that are satisfied by certain predetermined pairs of points and surfaces (Step 215). The constraints include at least parallel, perpendicular, tangent and concentric. This determination can be made automatically, although the user will have control over which types of constraints and pairs to use. For example, constraints can be applied between all pairs of parallel planes, all pairs of surfaces which intersect at an edge of the part or all pairs of surfaces which are adjacent to a third surface in the part. When selecting the constraints, a constraint solver is used to verify that the selected set of constraints yields a valid constraint scheme (Step 220) and if not, remove constraints until it does (Step 225). Some parts may require constraints to be added between edges (curves) in which case the curves (lines or circles) are added to the constraint solver and constrained coincident to their adjacent faces prior to adding the additional constraints.

Determine desirable dimensions to be added to the model (Step 230). These include the radius of certain geometries such as spheres and cylinders and the distances or angles between selected pairs of geometries. The precise form of the dimensioning scheme is determined by the type of dimensions which are applied and the order in which they are applied. The user is allowed some control over this scheme by the selection of options. When selecting the dimensions, a constraint solver is used to verify that the selected set of dimensions and constraints yields a valid constraint scheme (Step 235) and if not, remove dimensions in the reverse order to which they were added until it does (Step 240). The aim should be to add sufficient constraints and dimensions so that the geometry in the constraint solver is fully defined. Optionally, the user can add additional dimensions to allow particular changes to be made (Step 245). These additions, however, may result in an invalid model. The constraint solver will identify which constraints and other dimensions are conflicting and will allow the user to remove one or more of these until the model is valid. Optionally, the user may specify changes to one or more of the dimension values (Step 250). The constraint solver re-computes the geometry so that the dimensions (with the new values) and constraints are satisfied (Step 255). If sufficient constraints and dimensions have been added, the positions of the geometry in the constraint solver will be fully defined. The changes to the surfaces and the points calculated by the constraint solver will be input to the geometric modeler, either by giving their new definition or by giving the appropriate transform. The geometric modeler will use the surfaces to compute a new, valid model where the new part matches the surface geometries computed by the constraint solver (Step 260). Ambiguity in the definition of the part from the new face geometries is resolved using the new point geometries. Derived geometries (for example, blends and intersection curves) are computed by the geometric modeler from the surface geometry.

### Application

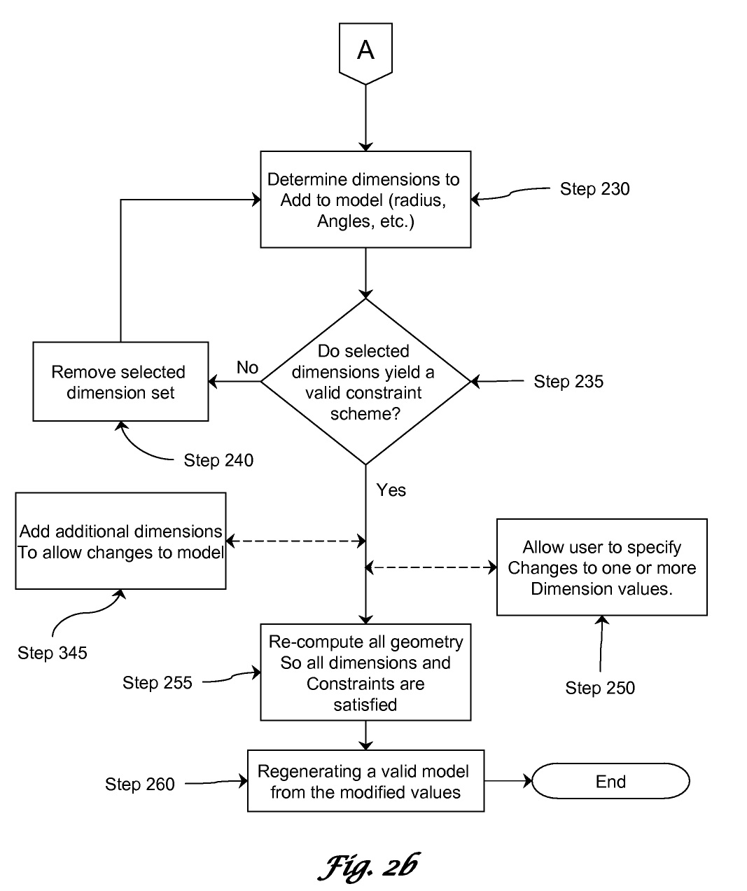

FIGS. 3A & 3B illustrate a three-dimensional boundary representation model. Referring to FIG. 3A, a solid sphere 300 has a blind cylindrical hole 305 positioned off-centre. A number of hidden internal edges 310 are shown for clarity. Referring to FIG. 3B, the solid sphere 300 has been read into the constraint solver and the following geometries have been read into the constraint solver: (1) the solid sphere 300 (which appears as a circle in this two-dimensional view); (2) the blind cylindrical hole 305 (which appears as two parallel silhouette lines in this two-dimensional view); (3) a plane 315 (which appears as a line in this two-dimensional view); (4) a point1 320 that is on an intersection edge between the solid sphere 300 and the blind cylindrical hole 305; (5) a point2 325 that is on a circular edge between the plane 315 and the blind cylindrical hole 305. The two edges are not read into the constraint solver, only the two points (320,325) that lie on these edges.

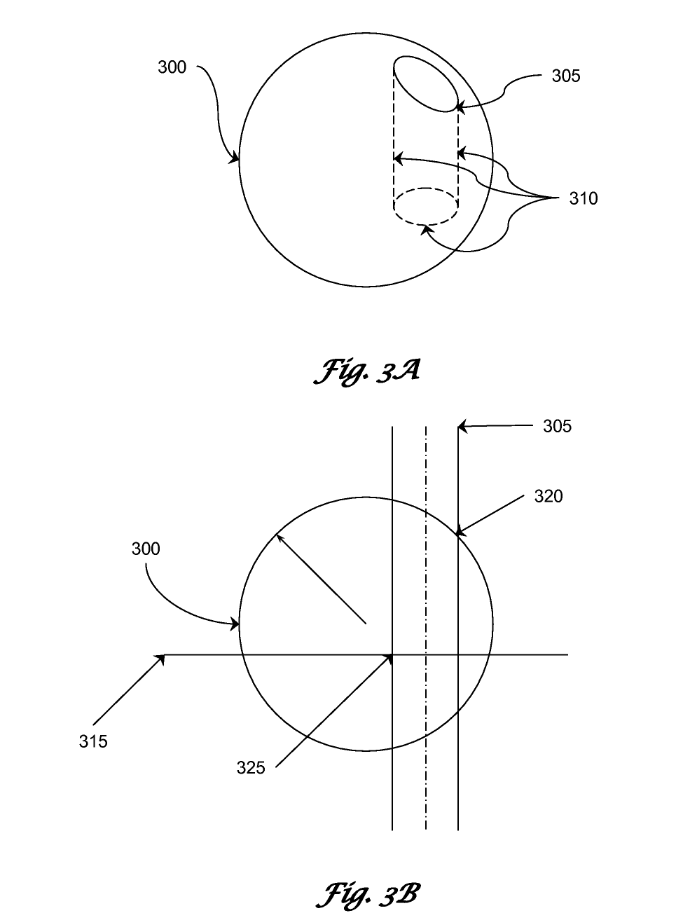

FIG. 4 illustrates a three-dimensional boundary representation (b-rep) model with constraints and dimensions applied to it pursuant to the method and system disclosed in the presently preferred embodiment. Referring to FIG. 4, the b-rep model with constraints and dimensions are applied in the following sequence: (1) constraints that represent the connectivity of the b-rep model, point1 is constrained coincident to cylinders and sphere1 and point2 is constrained coincident to cylinders and plane1; (2) constraints which capture the geometric intent on the model, a parallel constraint between the cylinder axis direction and the plane normal direction; and (3) dimensions which will allow the model to be changed, Sphere1 is given a radius dimension, Cylinder1 is given a radius dimension, Plane1 has a distance dimension to the nearest point on the surface of sphere1, and Cylinder1 has a distance dimension to the nearest point on the surface of sphere1. In this particular example, Step 210 and Step 225 are not necessary.

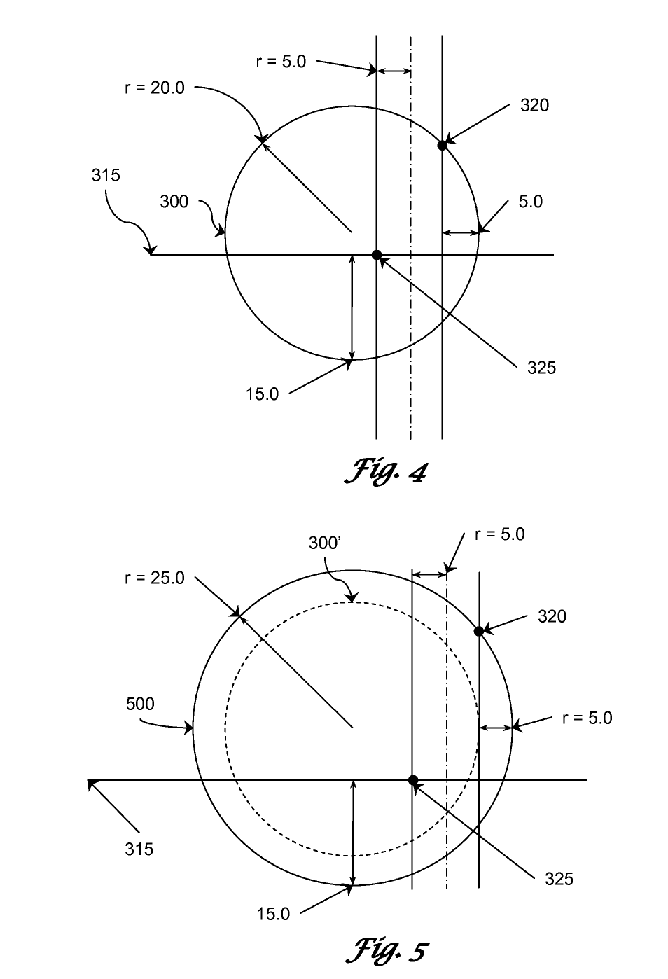

FIG. 5 illustrates the result on a three-dimensional boundary representation model with modified constraints and dimensions applied to it pursuant to the method and system disclosed in the presently preferred embodiment. Referring to FIG. 5, a modified sphere 500 illustrates where the radius of the solid sphere 300′ has been modified from 20.0 to 25.0, while the constraint solver maintained all other constraints and dimensions. The output of this step is the new definitions of all of the geometries (Step 235). These are then input to the geometric modeler (Step 120). Note that there are two possible curves of intersection between the unbounded cylinder and the sphere. The purpose of point1 320 is to distinguish between these two curves by identifying the point that lies on the curve of interest.

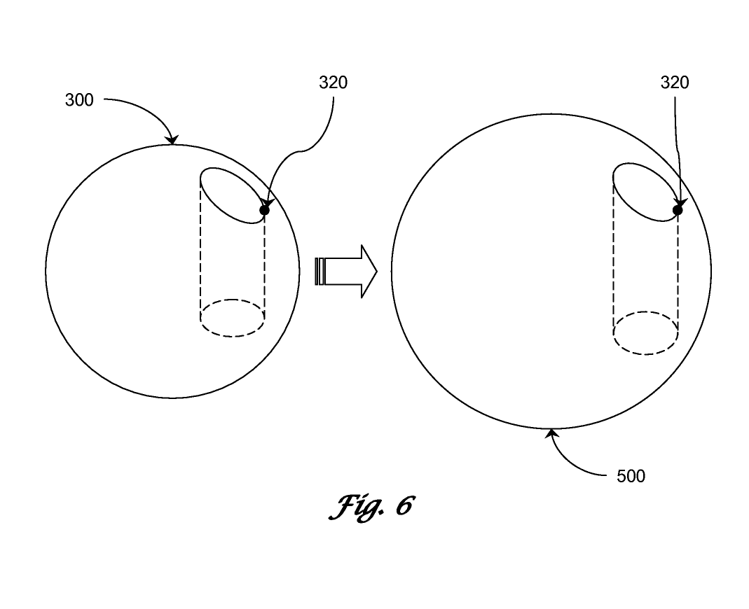

FIG. 6 illustrates the transition from the solid sphere 300 to its modified form 500. Referring to FIG. 6, for the modified solid sphere 500, the geometric modeler recreated the intersection curve between the sphere and the cylinder, using the point1 320 to choose the correct solution.

### CONCLUSION

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments have been described. It will be understood that various modifications may be made without departing from the spirit and scope of the presently preferred embodiment, Therefore, other implementations are within the scope of the following claims.

What is claimed is:

1. A method of modifying a model, comprising the steps of:
reading a model geometry into a constraint solver;
generating a set of base values from said constraint solver;
applying said set of base values to said model geometry;
recalculating said model geometry in response to a plurality of modified values; and
regenerating a valid model from said recalculated model geometries.

2. The method of claim 1, wherein said model geometry is a boundary representation model.

3. The method of claim 1, wherein said model geometry is a subset of said model geometry.

4. The method of claim 1, wherein said base values are constraints.

5. The method of claim 1, wherein said base values are dimensions.

6. The method of claim 1, wherein said plurality of modified values is of at least one dimension.

7. The method of claim 1, wherein said recalculated model geometries creates a new model geometry.

8. The method of claim 1, further comprising the step of representing a plurality of vertices and faces from said model geometry as a plurality of points and surfaces.

9. The method of claim 1, further comprising the step of applying a plurality of coincident constraints between said plurality of points and surfaces.

10. The method of claim 1, further comprising the step of determining a plurality of predetermined pairs of a plurality of geometries that satisfy a plurality of relationships.

11. The method of claim 1, further comprising the step of determining a plurality of desirable dimension values.

12. The method of claim 11, further comprising the step of applying said dimension values to said constraint solver.

13. The method of claim 12, further comprising the step of changing a plurality of dimension values.

14. The method of claim 11, wherein said plurality of predetermined pairs are one of parallel, perpendicular, tangent, concentric, and geometrically coincident surfaces.

15. The method of claim 11, wherein said plurality of desirable dimension values is a radius of one of a sphere, a cylinder, and a torus.

16. The method of claim 11, wherein said plurality of desirable dimension values is a distance between a pair of selected geometries.

17. The method of claim 11, wherein said plurality of desirable dimensions is an angle between a pair of selected geometries.

18. A method of modifying a model, comprising the steps of:
representing a geometry as a plurality of points and a plurality of surfaces;
applying a plurality of coincident constraints among said geometry;
determining a plurality of constraints satisfying said plurality of points and said plurality of surfaces;
adding at least one dimension to a model geometry;
re-computing said geometry to satisfy said at least one dimension and said plurality of constraints; and
regenerating a valid model from said re-computed geometry.

19. The method of claim 18, wherein said geometry is a subset geometry.

20. The method of claim 18, wherein said geometry consists primarily of a plurality of vertices and a plurality of surfaces.

21. The method of claim 18, further comprising the step of applying a plurality of dimensions to a solver, wherein said solver changes said model geometry.

22. The method of claim 18, further comprising the step of adding a plurality of dimensions to said model geometry.

23. The method of claim 18, further comprising the step of modifying at least one dimension value.

24. The method of claim 18, further comprising the step of removing at least one dimension from said model geometry.

25. The method of claim 18, further comprising the step of removing at least one constraint from said model geometry.

26. A computer-program product tangibly embodied in a machine readable medium to perform method of modifying a model, comprising:
instructions for reading a model geometry into a constraint solver;
instructions for generating a set of base values from said constraint solver;
instructions for applying said set of base values to said model geometry;
instructions for recalculating said model geometry in response to a plurality of modified values; and
instructions for regenerating a valid model from said recalculated model geometries.

27. The computer-program product of claim 26, wherein said model geometry is a boundary representation model.

28. The computer-program product of claim 26, wherein said model geometry is a subset of said model geometry.

29. The computer-program product of claim 26, wherein said base values are constraints.

30. The computer-program product of claim 26, wherein said base values are dimensions.

31. The computer-program product of claim 26, wherein said plurality of modified values is of at least one dimension.

32. The computer-program product of claim 26, wherein said recalculated model geometries creates a new model geometry.

33. The computer-program product of claim 26, further comprising instructions for representing a plurality of vertices and faces from said model geometry as a plurality of points and surfaces.

34. The computer-program product of claim 26, further comprising instructions for applying a plurality of coincident constraints between said plurality of points and surfaces.

35. The computer-program product of claim 26, further comprising instructions for determining a plurality of predetermined pairs of a plurality of geometries that satisfy a plurality of relationships.

36. The computer-program product of claim 26, further comprising instructions for determining a plurality of desirable dimension values.

37. The computer-program product of claim 36, further comprising instructions for applying said dimension values to said constraint solver.

38. The computer-program product of claim 37, further comprising instructions for changing a plurality of dimension values.

39. The computer-program product of claim 36, wherein said plurality of predetermined pairs are one of parallel, perpendicular, tangent, concentric, and geometrically coincident surfaces.

40. The computer-program product of claim 36, wherein said plurality of desirable dimension values is a radius of one of a sphere, a cylinder, and a torus.

41. The computer-program product of claim 36, wherein said plurality of desirable dimension values is a distance between a pair of selected geometries.

42. The computer-program product of claim 36, wherein said plurality of desirable dimensions is an angle between a pair of selected geometries.

43. A computer-program product tangibly embodied in a machine readable medium to perform method of modifying a model, comprising:
instructions for representing a geometry as a plurality of points and a plurality of surfaces;
instructions for applying a plurality of coincident constraints among said geometry;
instructions for determining a plurality of constraints satisfying said plurality of points and said plurality of surfaces;
instructions for adding at least one dimension to a model geometry;
instructions for re-computing said geometry to satisfy said at least one dimension and said plurality of constraints; and
instructions for regenerating a valid model from said re-computed geometry.

44. The computer-program product of claim 43, wherein said geometry is a subset geometry.

45. The computer-program product of claim 43, wherein said geometry consists primarily of a plurality of vertices and a plurality of surfaces.

46. The computer-program product of claim 43, further comprising instructions for applying a plurality of dimensions to a solver, wherein said solver changes said model geometry.

47. The computer-program product of claim 43, further comprising instructions for adding a plurality of dimensions to said model geometry.

48. The computer-program product of claim 43, further comprising instructions for modifying at least one dimension value.

49. The computer-program product of claim 43, further comprising instructions for removing at least one dimension from said model geometry.

50. The computer-program product of claim 43, further comprising instructions for removing at least one constraint from said model geometry.

51. A data processing system having at least a processor and accessible memory to implement a method of modifying a model, comprising:
means for reading a model geometry into a constraint solver;
means for generating a set of base values from said constraint solver;
means for applying said set of base values to said model geometry;
means for recalculating said model geometry in response to a plurality of modified values; and
means for regenerating a valid model from said recalculated model geometries.
